(19) United States
(12) Patent Application Publication
(10) Pub. No.: US 2026/0348883 A1
(43) Pub. Date: Nov. 5, 2026

(54) MULTI-ANGLE X-RAY EMISSION GENERATION MODULE FOR COMPUTED TOMOGRAPHY APPARATUS AND COMPUTED TOMOGRAPHY METHOD USING THE SAME

(71) Applicant: Scientific Gear Service Co., Ltd., Miaoli County (TW)

(72) Inventors: CHING-SHUN KU, Miaoli County (TW); CHIA-HSIEN LIN, Miaoli County (TW); BO-SHU TSAI, Miaoli County (TW); LIN-SHENG FU, Miaoli County (TW)

(21) Appl. No.: 19/662,260

(22) Filed: Apr. 29, 2026

Related U.S. Application Data
(60) Provisional application No. 63/798,056, filed on May 1, 2025.

(51) Int. Cl. G01N 23/046; G06T 12/30

(52) U.S. Cl. CPC G01N 23/046; G06T 12/30; G01N 2223/1016; G01N 2223/3307; G01N 2223/419; G01N 2223/6116; G06T 2211/441

(57) ABSTRACT

A multi-angle X-ray emission generation module for computed tomography apparatus comprises a stage, an X-ray emitter, a multi-angle emission point generation module, and at least one detector, wherein the X-ray emitter and the multi-angle emission point generation module are disposed on one side of the stage and the at least one detector is disposed on another side of the stage. The stage can move a target region of a test object to an imaging region. The multi-angle emission point generation module receives the X-ray emitted from the X-ray emitter to form a plurality of outgoing X-rays from different positions toward the imaging region. The at least one detector is configured to receive the outgoing X-rays passing through the target region and obtain images of target region from different angles. The images of target region are used to reconstruct a three-dimensional tomographic image of the target region.

### BACKGROUND OF THE INVENTION

### 1. Field of the invention

The present invention relates to a multi-angle X-ray emission generation module for computed tomography apparatus and a computed tomography method using the same, and more particularly, to a multi-angle X-ray emission generation module for computed tomography apparatus and a computed tomography method using the same capable of semiconductor inspection.

### 2. Description of the prior art

With the rapid advancement of technology, semiconductor devices have been widely adopted in consumer electronics, communication equipment, electric vehicles, artificial intelligence, and high-performance computing, and have become an indispensable core technology in various critical systems. With the continuous advancements in manufacturing processes, the structures of semiconductor devices are becoming increasingly complex. To maintain yield rates, effectively detecting internal structural defects in semiconductor devices and improving inspection efficiency have become critical issues in semiconductor manufacturing and quality control. In the prior art, an X-ray computed tomography (CT) system can be used to inspect the internal structures of semiconductor devices.

The X-ray computed tomography device of the prior art employs a configuration comprising a single X-ray emission point and a single two-dimensional detector. For flat semiconductor samples, there are two scanning methods: keeping the X-ray emission point stationary while simultaneously driving the semiconductor sample and the detector to perform corresponding circular motions, and capturing images at different positions; alternatively, keeping the semiconductor sample stationary while simultaneously driving the X-ray emission point and detector to perform out-of-phase circular motions, and capturing images at different positions. In both of the above scanning methods, structural images of a single specific region within the semiconductor sample can be obtained from different angles at various positions. These structural images from different angles can be used to reconstruct a three-dimensional tomographic image of the specific region, and through this three-dimensional tomographic image, the structural defects at the specific region can be detected. However, at a time point, the X-ray tomography device of the prior art can only capture a single two-dimensional image of a specific region of the sample from a single specific angle. To obtain images from other specific angles, the sample scanning mechanism must drive the detector and the semiconductor sample or the X-ray emission point to perform the aforementioned motions to move to different positions and then the images from other angles of the same specific region can be captured. To fully acquire the images of a single specific region of the semiconductor sample from multiple different angles, the above process must be repeated for many times. The repeated waiting for the sample scanning mechanism to move and reposition significantly increases scanning time. Furthermore, in semiconductor inspection, a single semiconductor sample is not tested for just one specific region but for multiple regions, and the repeated movement and repositioning of the sample scanning mechanism described above will substantially increase inspection time and costs.

Therefore, there is an urgent need for a new type of X-ray computed tomography device to solve the above problem of the prior art.

### SUMMARY OF THE INVENTION

In view of this, the present invention provides a multi-angle X-ray emission generation module for computed tomography apparatus. According to an embodiment, the multi-angle X-ray emission generation module for computed tomography apparatus comprises: a stage comprising a moving unit, the moving unit being configured to carry and drive a test object to move, wherein the stage has an imaging region; an X-ray emitter disposed on one side of the stage, wherein the X-ray emitter has an emission terminal to emit an X-ray; a multi-angle emission point generation module disposed on the side of the stage, wherein the multi-angle emission point generation module is configured to receive the X-ray emitted by the X-ray emitter and form the X-ray into a plurality of outgoing X-rays simultaneously emitted from different positions toward the imaging region; and, at least one detector disposed on another side of the stage, wherein the at least one detector is configured to receive the outgoing X-rays passing through the imaging region. When the moving unit drives a target region of the test object to move into the imaging region, the outgoing X-rays pass through the imaging region and the target region of the test object to be received by the at least one detector, and the at least one detector obtains a plurality of images of target region from different angles within a single positioning of the test object based on the outgoing X-rays.

Wherein, the at least one detector comprises a detection surface, and the detection surface comprises a plurality of sub-detection surfaces respectively configured to receive the outgoing X-rays incident at different angles and obtain the images of target region.

Wherein, the detection surface of the at least one detector is divided into the sub-detection surfaces by physical partitioning or by software-based partitioning.

Wherein, the multi-angle X-ray emission generation module for computed tomography apparatus comprises a reconstruction module connected to the at least one detector, the reconstruction module being configured to receive the images of target region from the at least one detector and reconstruct a three-dimensional tomographic image of the target region of the test object based on the images of target region.

Wherein, the reconstruction module comprises at least one artificial intelligence (AI) model. The at least one AI model is configured to perform a denoising process on the images of target region to generate high-quality two-dimensional images, perform a sparse three-dimensional reconstruction process on the high-quality two-dimensional images to generate a full-view three-dimensional image, and perform a super-resolution process on the full-view three-dimensional image to generate a high-resolution three-dimensional tomographic image. The training dataset used for training the at least one AI model comprises datasets of long-exposure images and short-exposure images for different sample forms, datasets of large-angle images and small-angle images, and datasets of segmented and non-segmented images for the imaging region.

Wherein, the multi-angle emission point generation module comprises a reflector disposed around the emission terminal. The reflector has a reflective curved surface corresponding to an energy of the X-ray, and the reflective curved surface is configured to reflect the X-ray at different positions thereon to form the outgoing X-rays.

Wherein, the multi-angle emission point generation module comprises a curved thin crystal disposed between the stage and the emission terminal. One side of the curved thin crystal is configured to receive the X-ray and another side of the curved thin crystal is configured to form the outgoing X-rays. The curved thin crystal is one of a single crystal, a multilayer crystal, and a metal thin film. The curved thin crystal has a curvature distribution, and the curved thin crystal has different crystal orientations to adjust the transmission energy and the reflection energy of X-rays within the curved thin crystal.

Wherein, the multi-angle emission point generation module comprises a perforated shielding plate disposed between the stage and the emission terminal. The perforated shielding plate has a plurality of openings, and the perforated shielding plate is configured to block a portion of the X-ray and allow the unblocked portion of the X-ray to pass through the openings to form the outgoing X-rays.

Wherein, a crystal is configured in each of the openings of the perforated shielding plate for the X-ray to pass through to form the outgoing X-rays.

Wherein, the multi-angle X-ray emission generation module for computed tomography apparatus further comprises a mask configured between the stage and the multi-angle emission point generation module. The mask is configured to block portions of the outgoing X-rays and allow the unblock portions of the outgoing X-rays to pass through the imaging region for controlling the emission angle distribution of the outgoing X-rays, dose shaping, and selective angular filtering.

Wherein, the at least one detector comprises a plurality of detectors respectively configured to receive the outgoing X-rays and obtain the images of target region.

The present invention also provides a computed tomography method using multi-angle X-ray emission generation module. According to an embodiment, the method comprises the following steps: placing a test object on a moving unit of a stage to move a target region of the test object into an imaging region of the stage; using an X-ray emitter to emit an X-ray, and using a multi-angle emission point generation module to receive the X-ray and form the X-ray into a plurality of outgoing X-rays simultaneously emitted from different positions toward the imaging region; and, using a at least one detector to receive the outgoing X-rays passing through the imaging region and the target region of the test object, so as to obtain a plurality of images of target region from different angles.

Wherein, the method further comprises the following step: using a reconstruction module to receive the images of target region from the at least one detector and reconstruct a three-dimensional tomographic image of the target region of the test object based on the images of target region.

Wherein, the method further comprises the following step: using the reconstruction module to receive the images of target region generated by the at least one detector, and using at least one AI model of the reconstruction module to perform a denoising process to generate high-quality images, perform a sparse three-dimensional reconstruction process on the high-quality images to generate a full-view image, and perform a super-resolution process on the full-view image to generate a high-resolution three-dimensional tomographic image. The training dataset used for training the at least one AI model comprises datasets of long-exposure images and short-exposure images for different sample forms, datasets of large-angle images and small-angle images, and datasets of segmented and non-segmented images for the imaging region.

Wherein, the multi-angle emission point generation module forms the X-ray into the outgoing X-rays from different positions toward the imaging region by one of a reflector, a curved thin crystal, a perforated shielding plate, and a combination thereof.

Wherein, the at least one detector receives the outgoing X-rays by a detector having a plurality of sub-detection surfaces or by a plurality of detectors.

In summary, the multi-angle X-ray emission generation module for computed tomography apparatus and the computed tomography method using the same of the present invention can provide outgoing X-rays from different directions to the test object within the imaging region by an X-ray emitter in conjunction with a multi-angle emission point generation module. After passing through the test object, the outgoing X-rays from different directions are respectively received by a detector having a plurality of sub-detection surfaces or by a plurality of detectors, thereby obtaining a plurality of images of target region from different angles and reconstructing a three-dimensional tomographic image of the target region. Wherein, the sub-detection surfaces of a single detector can be divided by physical partitioning or by software-based partitioning. In addition, the multi-angle emission point generation module can include a reflector, a curved thin crystal, or a perforated shielding plate. Compared to the prior art, which requires movement and positioning before obtaining a two-dimensional image at each angle, the computed tomographic device and method of the present invention using a multi-angle X-ray generation module merely move the target region to the imaging region to obtain the two-dimensional images from different angles at once, significantly reducing the inspection time. Furthermore, by using the multi-angle emission point generation module to form a single X-ray into multiple X-rays passing through the imaging region and the test object from different directions, the manufacturing cost of the computed tomographic device using the multi-angle emission X-ray generation module can also be reduced. In summary, multi-angle X-ray emission generation module for computed tomography apparatus and the computed tomography method using the same of the present invention can significantly reduce inpsection time and costs.

### BRIEF DESCRIPTION OF THE APPENDED DRAWINGS

FIG. 1 is a schematic diagram illustrating s according to an embodiment of the present invention.

FIG. 2 is a schematic diagram illustrating the multi-angle X-ray emission generation module for computed tomography apparatus of FIG. 1 performing an inspection on a test object.

FIG. 3 is a schematic diagram illustrating a multi-angle X-ray emission generation module for computed tomography apparatus performing an inspection on the test object according to another embodiment of the present invention.

FIG. 4 is a schematic diagram illustrating a schematic diagram illustrating a multi-angle X-ray emission generation module for computed tomography apparatus 1 performing an inspection on the test object according to another embodiment of the present invention.

FIG. 5 is a schematic diagram illustrating a multi-angle X-ray emission generation module for computed tomography apparatus performing an inspection on the test object according to another embodiment of the present invention.

FIG. 6 is a flowchart illustrating a computed tomography method using multi-angle X-ray generation module according to an embodiment of the present invention.

FIG. 7 is a flowchart illustrating a computed tomography method using multi-angle X-ray generation module according to another embodiment of the present invention.

### DETAILED DESCRIPTION OF THE INVENTION

For the sake of the advantages and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments.

In the descriptions of this specification, the terms “an embodiment,” “another embodiment,” or “some embodiments” refer to at least one embodiment of the present invention that includes the specific features, structures, materials, or characteristics described in the embodiment. In this specification, the illustrative expressions of the above terms do not necessarily refer to the same embodiment. Furthermore, the specific features, structures, materials, or characteristics described may be combined in any one or more embodiments in an appropriate manner.

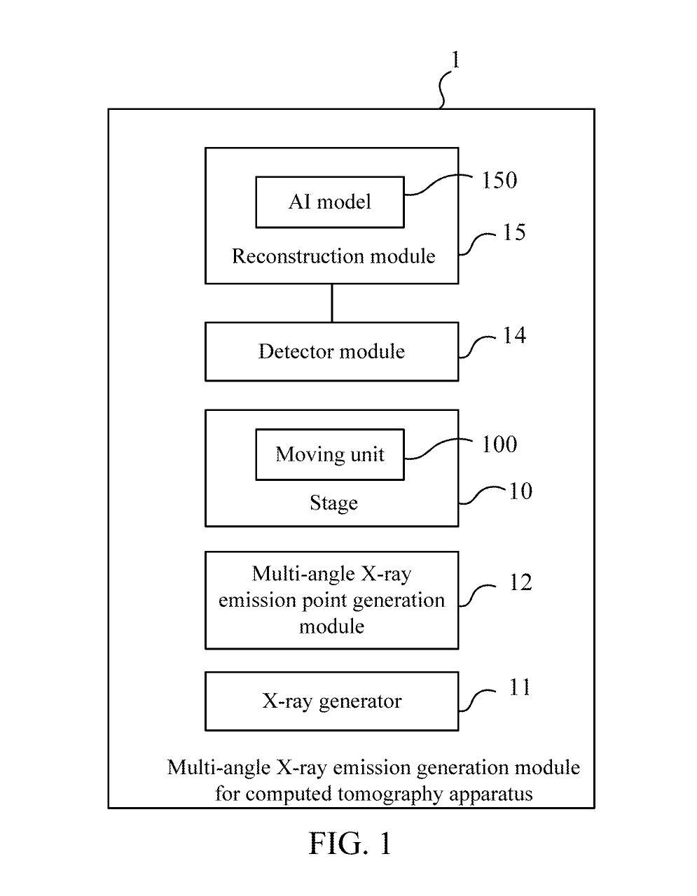

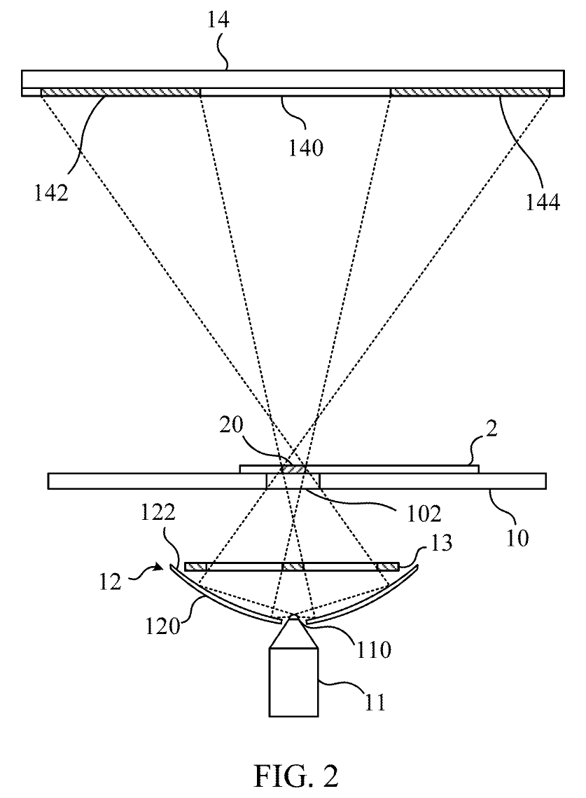

Please refer to FIGS. 1 and 2 together. FIG. 1 is a schematic diagram of a multi-angle X-ray emission generation module for computed tomography apparatus 1 according to an embodiment of the present invention, and FIG. 2 is a schematic diagram illustrating the multi-angle X-ray emission generation module for computed tomography apparatus 1 of FIG. 1 performing an inspection on a test object 2. As shown in FIG. 1, the multi-angle X-ray emission generation module for computed tomography apparatus 1 of this embodiment comprises a stage 10, an X-ray emitter 11, a multi-angle emission point generation module 12, a mask 13, and a detector module 14, wherein the stage 10 includes a moving unit 100 and an imaging region 102. Furthermore, as shown in FIG. 2, the X-ray emitter 11 is disposed on one side of the stage 10 and includes an emission terminal 110 capable of emitting X-rays. The multi-angle emission point generation module 12 can include a reflector 120 arranged around the emission terminal 110, wherein the reflector 120 has a reflective curved surface 122 facing the stage 10. The reflective curved surface 122 is corresponding to the energy of the X-ray emitted from the emission terminal 110 to reflect the X-ray toward the stage 10. The mask 13 is disposed between the X-ray emitter 11 and the stage 10 to block a portion of the X-ray reflected by the reflector 120. The detector module 14 is disposed on another side of the stage 10 to receive the reflected light passing through the imaging region and form an image. In practice, the detector module 14 comprises at least one detector.

In this embodiment, the stage 10 is configured to support the flat-shaped test object 2 thereon and to move the test object 2 via the moving unit 100 (for the sake of simplicity, the moving unit is omitted in FIG. 2). In practice, the test object 2 can be, but not limited to, a semiconductor wafer. The moving unit 100 moves the target region 20 of the test object 2 above the imaging region 102 of the stage 10, so that the target region 20 can captured as two-dimensional structural images from multiple angles within the imaging region 102. These two-dimensional structural images can be reconstructed into a three-dimensional tomographic image to determine whether there are structural defects in the target region 20.

As shown in FIG. 2, when the target region 20 is moved on the imaging region 102, the emission terminal 110 of the X-ray emitter 11 emits an X-ray, which diverges and is reflected by the reflective curved surface 122 of the reflector 120. The reflected lights can be regarded as the outgoing X-rays from the reflector 120. The outgoing X-rays are angularly distributed X-ray beams. The reflective curved surface 122 is an approximately elliptical surface, and the focal position of the reflected lights of the X-ray, emitted from the emission terminal 110, reflected by the reflective curved surface 122 is determined by its geometric shape or curvature distribution. In this embodiment, the reflective curved surface 122 focuses the reflected X-rays onto the imaging region 102. As described above, the mask 13 is disposed between the X-ray emitter 11 and the stage 10 to block portions of the reflected X-rays generated by the reflector 120, and then the unblocked portions of the reflected X-rays can pass through the imaging region 102 from different directions and further pass through the target region 20 located on the imaging region 102. The mask 13 can be used to restrict the non-effective paths of the reflected light, such as the other parts of the test object 2 outside the target region 20, to prevent the test object 2 from receiving excessive radiation doses that could cause damage. Furthermore, the mask 13 can also be used for dose shaping and selective angular filtering. The detector module 14, disposed on the opposite side of the stage 10, receives the X-ray reflected lights passing through the target region 20 from different directions. As shown in FIG. 2, the detector module 14 comprises a first detection surface 142 and a second detection surface 144, and both of them are portions of detection surface 140. The first detection surface 142 and the second detection surface 144 respectively receive the X-ray reflected lights reflected by the left portion and the right portion of the reflective curved surface 122 around the emission terminal 110 and passing through the target region 20. Therefore, they can each generate the images of the target region from different angles. It should be noted that FIG. 2 is merely a schematic diagram showing a side view of the multi-angle X-ray emission generation module for computed tomography apparatus 1. In practice, the reflector 120 does not only reflect X-rays from the positions shown in FIG. 2, nor does the detector module 14 only have a first detection surface 142 and a second detection surface 144 to receive the reflected X-rays. Rather, it can reflect X-rays from multiple angles and receive the reflected lights passing through the target region 20 using multiple sub-detection surfaces. For example, the reflective curved surface 122 of the reflector 120 can be arranged in a ring configuration around the emission terminal 110. Therefore, the entire curved surface around the emission terminal 110 can reflect X-rays, and a plurality of sub-detection surfaces can be arranged in a ring configuration on the detection surface of the detector module 14 to correspondingly receive these reflected X-rays, thereby obtaining the images of the target region from different angles along the ring arrangement.

Therefore, the moving unit 100 only needs to move the test object 2 once to obtain, in a single step, a plurality of two-dimensional structural images of the single target region 20 from different angles.

The first detection surface 142, second detection surface 144, or other sub-detection surfaces used to receive the reflected lights can be achieved in practice by physical partitioning or software-based partitioning of the detection surface 140. Thus, a single detector module 14 can perform the function of obtaining multiple two-dimensional structural images from different angles. Furthermore, since the detection surface 140 is substantially parallel to the stage 10 and the test object 2 with the plate shape supported thereon, the divided sub-detection surfaces are all located on a plane parallel to the stage 10 and the test object 2, so that the images of target region obtained at different angles by the sub-detection surfaces have the same magnification, allowing them to be directly used to reconstruct the three-dimensional tomographic image without the need for magnification correction.

Please refer to FIG. 1 again. The multi-angle X-ray emission generation module for computed tomography apparatus 1 further comprises a reconstruction module 15 connected to the detector module 14 to receive the images of target region from different angles generated by the sub-detection surfaces of the detector module 14, and to reconstruct these two-dimensional structural images into the three-dimensional tomographic image of the structure within the target region 20, for subsequently determining whether there are defects in the structure within the target region 20.

Furthermore, in this embodiment, the function of the reconstruction module 15 to reconstruct the three-dimensional tomographic image based on the two-dimensional structural images obtained at different angles can be achieved using artificial intelligence (AI). Please refer again to FIG. 1. In this embodiment, the reconstruction module 15 includes at least one AI model 150. The AI model 150 is used to perform denoising process on the images of target region to generate high-quality two-dimensional images, to perform sparse three-dimensional reconstruction process on the high-quality two-dimensional images to generate a full-view three-dimensional image, and to perform super-resolution process on the full-view three-dimensional image to generate a high-resolution three-dimensional tomographic image. In practice, the process by which the AI model 150 performs super-resolution processing on the full-view three-dimensional images to generate the high-resolution three-dimensional tomographic image can specifically involve re-slicing the full-view three-dimensional image into two-dimensional distribution images of multiple image layers to select the necessary image layers for super-resolution processing, and then generating the high-resolution three-dimensional tomographic image. Compared to performing super-resolution processing on all image layers, the above approach merely performing the super-resolution process on the necessary image layers can further reduce the computational load of the AI model to improve efficiency. However, in practice, whether to perform super-resolution processing on the full-view three-dimensional images can be adjusted according to user requirements. The training dataset used to train the AI model 150 includes datasets of long-exposure images and short-exposure images for different sample forms, datasets of large-angle images and small-angle images, and datasets of segmented and non-segmented images for the imaging region.

Since these training dataset includes both a large number of two-dimensional images from different angles of the same target region and the three-dimensional tomographic image reconstructed based on them, as well as a small number of two-dimensional images from different angles and the three-dimensional tomographic image reconstructed based on them, the trained AI model is capable of simulating the three-dimensional tomographic image reconstructed based on a large number of two-dimensional images obtained at different angles using a small number of two-dimensional images obtained at different angles. Thereby, the AI model 150 can generate high-resolution three-dimensional tomographic images, which is originally generated based on a large number of the images of target region from different angles, even by a smaller number of the images of target region from different angles using fewer sub-detection surfaces.

Furthermore, the AI model 150 can include an artifact removal model for performing the super-resolution processing based on the full-view three-dimensional image to generate the high-resolution three-dimensional tomographic image. In other words, the artifact removal model can identify artifact structures based on the full-view three-dimensional image and removes the artifact structures to generate the high-resolution three-dimensional tomographic image. The artifact removal model is trained based on a machine learning algorithm by learning the corresponding relationships between a full-view three-dimensional image of a reference object, reconstructed from T two-dimensional images, and a high-resolution three-dimensional tomographic image, reconstructed from P two-dimensional images, where P > T. That is, the present invention can generate the high-resolution three-dimensional tomographic image from a small number of images of the test object using the artifact removal model to reduce the required number of the images and shorten the inspection time, thereby improving overall imaging efficiency and precision.

As aforementioned, the emission terminal 110 of the X-ray emitter 11 emits the X-ray, and the diverging X-ray is reflected at different angles by different portions of the reflective curved surface 122 of the reflector 120. Therefore, the reflected lights with different angles can be simultaneously obtained with a single X-ray emission of the X-ray emitter. In addition to the moving unit 100 moving the test object 2 only once, all of the sub-detection surfaces of the detector module 14 can simultaneously receive the X-ray reflected lights passing through the target region 20, thereby simultaneously obtaining the images of target region from different angles. It not only saves time of multiple movements and positioning but also saves time of sequentially emitting X-rays from different directions and imaging.

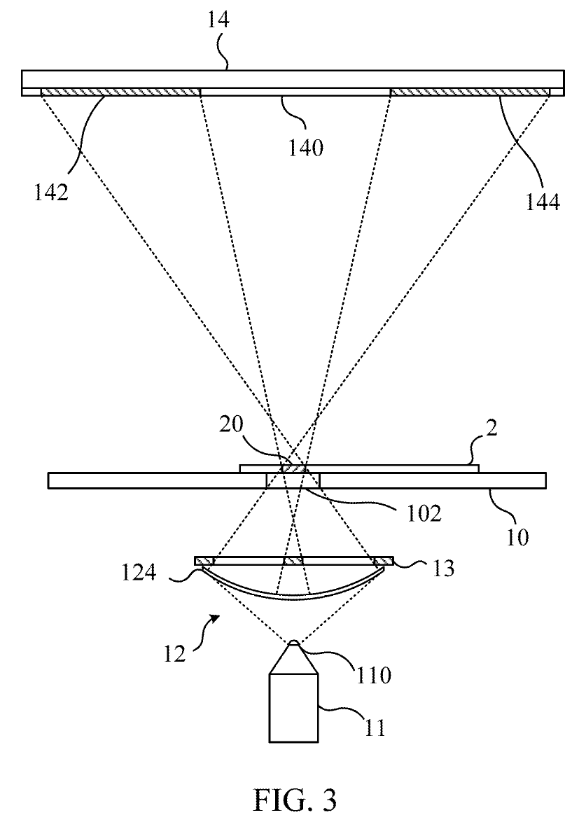

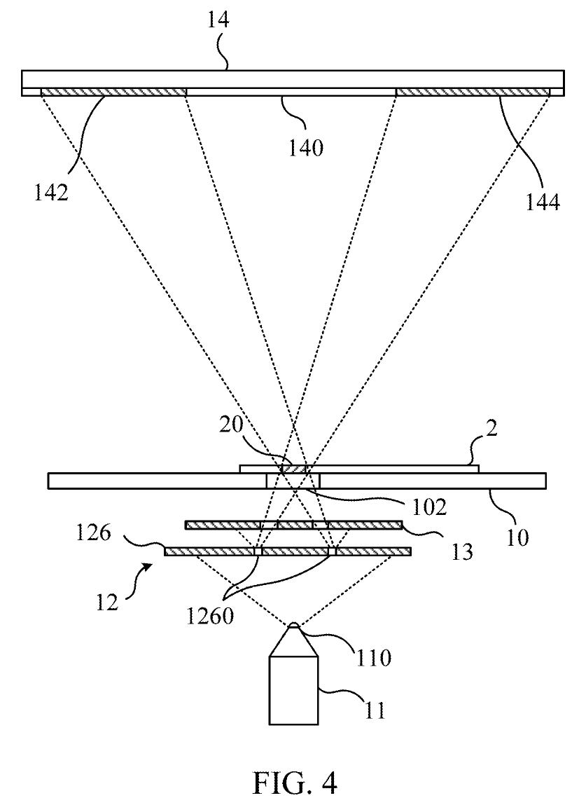

The multi-angle X-ray emission point generation module 12 of the present invention is not limited to the reflector 120 of the aforementioned embodiment. Please refer to FIGS. 3 and 4. FIG. 3 is a schematic diagram illustrating a multi-angle X-ray emission generation module for computed tomography apparatus 1 performing an inspection on the test object 2 according to another embodiment of the present invention. FIG. 4 is a schematic diagram illustrating a schematic diagram illustrating a multi-angle X-ray emission generation module for computed tomography apparatus 1 performing an inspection on the test object 2 according to another embodiment of the present invention. As shown in FIG. 3, the multi-angle emission point generation module 12 of this embodiment is a curved thin crystal 124, which is disposed between the stage 10 and the emission terminal 110 of the X-ray emitter 11. The X-ray emitted from the emission terminal 110 is incident on one side of the curved thin crystal 124, and based on the corresponding curvature distribution of the curved thin crystal 124, and a plurality of X-rays emerge from the other side of the curved thin crystal 124 to form the outgoing X-rays toward the imaging region 102 from multiple different positions. The outgoing X-rays are received by the detector module 14 to obtain the images of target region from different angles. In practice, the curved thin crystal 124 can be a single crystal, a multilayer crystal, a metal film, or any other crystal capable of allowing the X-ray to pass through and form the multiple outgoing X-rays toward the imaging region 102. Furthermore, the curved thin crystal 124 can have different crystal orientations to adjust the transmission energy and the reflection energy of X-rays within the curved thin crystal 124, thereby optimizing measurement results for different samples.

Furthermore, as shown in FIG. 4, the multi-angle emission point generation module 12 can be a perforated shielding plate 126, which is disposed between the stage 10 and the emission terminal 110 of the X-ray emitter 11 and has a plurality of openings 1260. The body of the perforated shielding plate 126 blocks the X-ray, while the openings 1260 allow the X-ray to pass through to form the outgoing X-rays toward the imaging region 102 from different positions. Furthermore, in practice, the multi-angle emission point generation module can include other mechanisms capable of generating multiple X-ray emission points and is not limited to the embodiments described above. For example, the multi-angle emission point generation module can also include a combination of the aforementioned reflector, thin crystal, and perforated shielding plate, such as that a crystal can be disposed in each of the openings of the perforated shielding plate so that the outgoing X-rays emerging from the openings can be focused onto the imaging region. Similarly, the thin crystal, the perforated shielding plate, or other configurations of the multi-angle X-ray emission point generation module can also employ the mask to prevent the test object 2 from receiving excessive radiation doses that could cause damage.

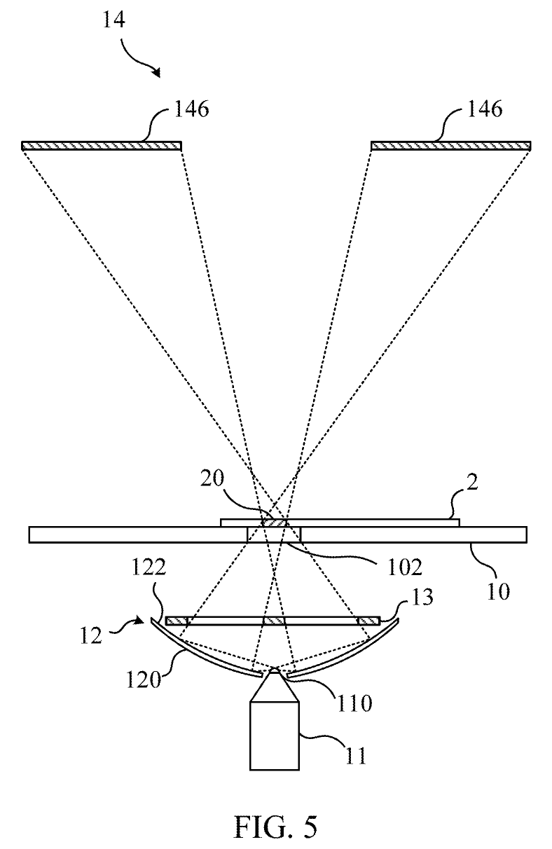

Furthermore, the multi-angle X-ray emission generation module for computed tomography apparatus of the present invention is not limited to imaging with a single detector. Please refer to FIG. 5. FIG. 5 is a schematic diagram illustrating a multi-angle X-ray emission generation module for computed tomography apparatus 1 performing an inspection on the test object 2 according to another embodiment of the present invention. As shown in FIG. 5, the detector module 14 of this embodiment comprises a plurality of detectors 146. The detectors 146 are respectively disposed at the locations corresponding to the outgoing X-rays to receive the corresponding outgoing X-rays from different angles, thereby obtaining the images of target region from different angles. To ensure the magnification of the images of target region being the same, the detectors 146 can be arranged on the same plane. The other units of this embodiment are the same as the corresponding units in the aforementioned embodiment, so that they would not be described in detail here. Similarly, the multi-angle emission point generation module of this embodiment is not limited to the reflector 120 in practice, but can be the curved thin crystal 124, the perforated shielding plate 126, or other suitable configurations. In practice, the detector module can include a single detector with multi-region or partition, multiple detectors, or time-multiplexed detection. Furthermore, the X-ray emission points formed by the multi-angle emission point generation module can also be adjusted according to a programmable/adaptive pattern as uniform or non-uniform distribution. For example, the X-ray emission points can be configured in a circular configuration, a linear configuration, a matrix configuration, and a non-uniform configuration.

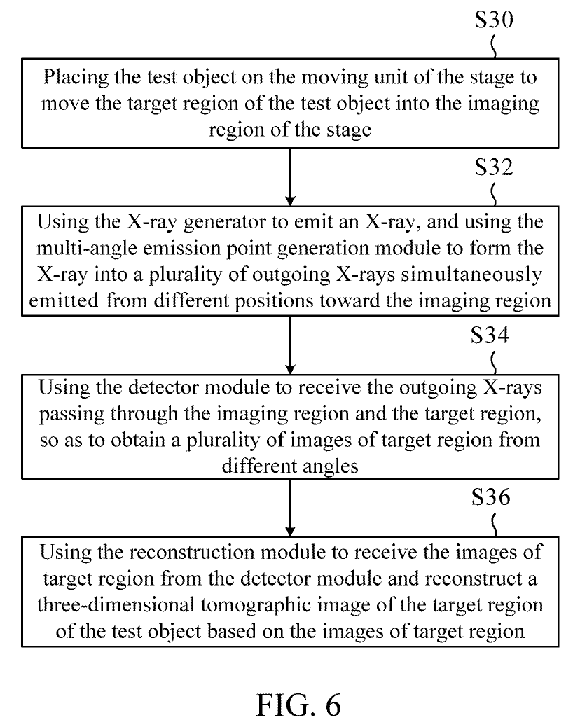

Please refer to FIG. 6. FIG. 6 is a flowchart illustrating a computed tomography method using multi-angle X-ray generation module according to an embodiment of the present invention. It should be noted that computed tomography method using multi-angle X-ray generation module of FIG. 6 can be achieved by the apparatus of the aforementioned embodiment. Therefore, the steps of this method are described with reference to the components of the multi-angle X-ray emission generation module for computed tomography apparatus 1. As shown in FIG. 6, the computed tomography method using multi-angle X-ray generation module of this embodiment comprises the following steps: step S30: placing the test object 2 on the moving unit 100 of the stage 10 to move the target region 20 of the test object 2 into the imaging region 102 of the stage 10; step S32: using the X-ray emitter 11 to emit an X-ray, and using the multi-angle emission point generation module 12 to form the X-ray into a plurality of outgoing X-rays simultaneously emitted from different positions toward the imaging region 102; and, step S34, using the detector module 14 to receive the outgoing X-rays passing through the imaging region 102 and the target region 20, so as to obtain a plurality of images of target region from different angles. The images of target region from different angles obtained by the method of this embodiment can be used to reconstruct a three-dimensional tomographic image of the target region 20. Therefore, the computed tomography method using multi-angle X-ray generation module further comprises the following step: step S36: using the reconstruction module 15 to receive the images of target region from the detector module 14 and reconstruct a three-dimensional tomographic image of the target region 20 of the test object 2 based on the images of target region.

In practice, for a test object, particularly a semiconductor wafer, it may be necessary to inspect multiple target regions for structural defects in order to determine the overall yield of the semiconductor wafer. For each target region, step S30 to step S36 can be repeated to obtain a three-dimensional tomographic image of that target region. Thus, the inspection for each target region requires only a single movement and positioning to obtain the images from multiple different angles, significantly reducing the inspection time.

As described in the above embodiments, the detector module 14 in step S34 of this embodiment can comprise the plurality of sub-detection surfaces on a single detector to receive the outgoing X-rays from different directions, or can comprise the plurality of detectors 146 to respectively receive the outgoing X-rays from different directions to generate the images of target region. Furthermore, the multi-angle emission point generation module 12 in step S32 of this embodiment can comprise the reflector 120, the curved thin crystal 124, or the perforated shielding plate 126 as aforementioned, thereby generating the outgoing X-rays from different positions directed toward the imaging region 102.

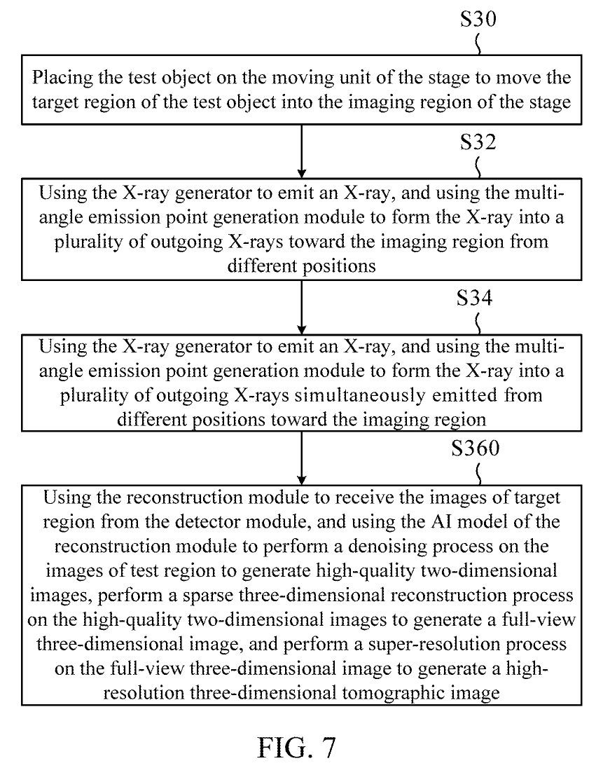

Similarly, the step in the computed tomography method using multi-angle X-ray generation module of the present invention for reconstructing the two-dimensional structural images from multiple different angles into the three-dimensional tomographic image can be achieved using an artificial intelligence module. Please refer to FIG. 7. FIG. 7 is a flowchart illustrating a computed tomography method using multi-angle X-ray generation module according to another embodiment of the present invention. As shown in FIG. 7, the difference between this embodiment and the previous embodiment is that the method of this embodiment includes step S360: using the reconstruction module 15 to receive the images of target region from the detector module 14, and using the AI model 150 of the reconstruction module 15 to perform a denoising process on the images of test region to generate high-quality two-dimensional images, perform a sparse three-dimensional reconstruction process on the high-quality two-dimensional images to generate a full-view three-dimensional image, and perform a super-resolution process on the full-view three-dimensional image to generate a high-resolution three-dimensional tomographic image. It should be noted that the other steps of the method in this embodiment are substantially the same as the corresponding steps in the previous embodiment and are therefore not described in detail here.

In summary, the multi-angle X-ray emission generation module for computed tomography apparatus and the computed tomography method using the same of the present invention uses an X-ray emitter in conjunction with a multi-angle emission point generation module to achieve the effect of the X-rays incidence on the imaging region from multiple directions. Furthermore, by using a single detector with multiple sub-detection surface or using a plurality of detectors to respectively receive the outgoing X-rays from different directions, it is possible to obtain a plurality of two-dimensional structural images from different angles of a single target region in a single step with the stage merely moving and positioning the test object once to reconstruct a three-dimensional tomographic image, without rotating the test object. It significantly reduces the total imaging time and the inspection costs. Furthermore, by utilizing AI models, high-resolution three-dimensional tomographic images can be generated from a small number of two-dimensional images of the test object obtained from different angles. It not only improves efficiency and image accuracy but also effectively reduces the number of X-ray emission points and detectors required for three-dimensional tomographic image reconstruction.

With the examples and explanations mentioned above, the features and spirits of the present invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A multi-angle X-ray emission generation module for computed tomography apparatus, comprising:
a stage, comprising a moving unit, the moving unit being configured to carry and drive a test object to move, the stage having an imaging region;
an X-ray emitter, disposed on one side of the stage, the X-ray emitter having an emission terminal to emit an X-ray;
a multi-angle emission point generation module, disposed on the side of the stage, the multi-angle emission point generation module being configured to receive the X-ray emitted by the X-ray emitter and form the X-ray into a plurality of outgoing X-rays simultaneously emitted from different positions toward the imaging region; and
at least one detector, disposed on another side of the stage, the at least one detector being configured to receive the outgoing X-rays passing through the imaging region;
wherein, when the moving unit drives a target region of the test object to move into the imaging region, the outgoing X-rays pass through the imaging region and the target region of the test object to be received by the at least one detector, and the at least one detector simultaneously obtains a plurality of images of target region from different angles within a single positioning of the test object based on the outgoing X-rays.

2. The multi-angle X-ray emission generation module for computed tomography apparatus of claim 1, wherein the at least one detector comprises a detection surface, and the detection surface comprises a plurality of sub-detection surfaces respectively configured to receive the outgoing X-rays incident from different angles and obtain the images of target region.

3. The multi-angle X-ray emission generation module for computed tomography apparatus of claim 2, wherein the detection surface of the at least one detector is divided into the sub-detection surfaces by physical partitioning or by software-based partitioning.

4. The multi-angle X-ray emission generation module for computed tomography apparatus of claim 1, further comprising a reconstruction module connected to the at least one detector, the reconstruction module being configured to receive the images of target region from the at least one detector and reconstruct a three-dimensional tomographic image of the target region of the test object based on the images of target region.

5. The multi-angle X-ray emission generation module for computed tomography apparatus of claim 4, wherein the reconstruction module comprises at least one artificial intelligence (AI) model, the at least one AI model is configured to perform a denoising process on the images of target region to generate high-quality two-dimensional images, perform a sparse three-dimensional reconstruction process on the high-quality two-dimensional images to generate a full-view three-dimensional image, and perform a super-resolution process by an artifact removal model on the full-view three-dimensional image to generate a high-resolution three-dimensional tomographic image, wherein a training dataset used for training the at least one AI model comprises datasets of long-exposure images and short-exposure images for different sample forms, datasets of large-angle images and small-angle images, and datasets of segmented and non-segmented images for the imaging region.

6. The multi-angle X-ray emission generation module for computed tomography apparatus of claim 1, wherein the multi-angle emission point generation module comprises a reflector disposed around the emission terminal, the reflector has a reflective curved surface corresponding to an energy of the X-ray, and the reflective curved surface is configured to reflect the X-ray at different positions thereon to form the outgoing X-rays, the different positions are arranged in at least one of a circular configuration, a linear configuration, a matrix configuration, and a non-uniform configuration.

7. The multi-angle X-ray emission generation module for computed tomography apparatus of claim 1, wherein the multi-angle emission point generation module comprises a curved thin crystal disposed between the stage and the emission terminal, one side of the curved thin crystal is configured to receive the X-ray and another side of the curved thin crystal is configured to form the outgoing X-rays from different positions of the curved thin crystal, the different positions are arranged in at least one of a circular configuration, a linear configuration, a matrix configuration, and a non-uniform configuration, the curved thin crystal is one of a single crystal, a multilayer crystal, and a metal thin film, the curved thin crystal has a curvature distribution, and the curved thin crystal has different crystal orientations to adjust the transmission energy and the reflection energy of X-rays within the curved thin crystal.

8. The multi-angle X-ray emission generation module for computed tomography apparatus of claim 1, wherein the multi-angle emission point generation module comprises a perforated shielding plate disposed between the stage and the emission terminal, the perforated shielding plate has a plurality of openings, and the perforated shielding plate is configured to block a portion of the X-ray and allow the unblocked portion of the X-ray to pass through the openings to form the outgoing X-rays, wherein the openings are arranged in at least one of a circular configuration, a linear configuration, a matrix configuration, and a non-uniform configuration.

9. The multi-angle X-ray emission generation module for computed tomography apparatus of claim 8, wherein a crystal is configured in each of the openings of the perforated shielding plate for the X-ray to pass through to form the outgoing X-rays.

10. The multi-angle X-ray emission generation module for computed tomography apparatus of claim 1, further comprising a mask configured between the stage and the multi-angle emission point generation module, the mask being configured to block portions of the outgoing X-rays and allow the unblock portions of the outgoing X-rays to pass through the imaging region for controlling the emission angle distribution of the outgoing X-rays, dose shaping, and selective angular filtering.

11. The multi-angle X-ray emission generation module for computed tomography apparatus of claim 1, wherein the at least one detector comprises a plurality of detectors respectively configured to receive the outgoing X-rays and obtain the images of target region.

12. A computed tomography method using multi-angle X-ray emission generation module, comprising the following steps:
placing a test object on a moving unit of a stage to move a target region of the test object into an imaging region of the stage;
using an X-ray emitter to emit an X-ray, and using a multi-angle emission point generation module to receive the X-ray and form the X-ray into a plurality of outgoing X-rays simultaneously emitted from different positions toward the imaging region; and
using a at least one detector to receive the outgoing X-rays passing through the imaging region and the target region of the test object, so as to obtain a plurality of images of target region from different angles within a single positioning of the test object.

13. The computed tomography method using multi-angle X-ray emission generation module of claim 12, further comprising the following step:
using a reconstruction module to receive the images of target region from the at least one detector and reconstruct a three-dimensional tomographic image of the target region of the test object based on the images of target region.

14. The computed tomography method using multi-angle X-ray emission generation module of claim 13, further comprising the following step:
using the reconstruction module to receive the images of target region generated by the at least one detector, and using at least one AI model of the reconstruction module to perform a denoising process to generate high-quality images, perform a sparse three-dimensional reconstruction process on the high-quality images to generate a full-view image, and perform a super-resolution process on the full-view image to generate a high-resolution three-dimensional tomographic image;
wherein, a training dataset used for training the at least one AI model comprises datasets of long-exposure images and short-exposure images for different sample forms, datasets of large-angle images and small-angle images, and datasets of segmented and non-segmented images for the imaging region.

15. The computed tomography method using multi-angle X-ray emission generation module of claim 12, wherein the multi-angle emission point generation module forms the X-ray into the outgoing X-rays from different positions toward the imaging region by one of a reflector, a curved thin crystal, a perforated shielding plate, and a combination thereof.

16. The computed tomography method using multi-angle X-ray emission generation module of claim 12, wherein the at least one detector receives the outgoing X-rays by a detector having a plurality of sub-detection surfaces or by a plurality of detectors.
